(19) United States
(12) Patent Application Publication
(10) Pub. No.: US 2026/0059607 A1
(43) Pub. Date: Feb. 26, 2026

(54) FRAME NUMBER CORRECTION FOR DISCONTINUOUS RECEPTION

(71) Applicant: Telefonaktiebolaget LM Ericsson (publ), Stockholm (SE)

(72) Inventors: Jose Luis PRADAS, Stockholm (SE); Andra Mihaela VOICU, Herzogenrath (DE)

(21) Appl. No.: 19/099,485

(22) PCT Filed: Jul. 28, 2023
(86) PCT No.: PCT/EP2023/071089

§ 371 Date: Jan. 29, 2025

Related U.S. Application Data
(60) Provisional application No. 63/393,571, filed on Jul. 29, 2022.

(51) Int. Cl. H04W 76/28; H04W 52/02; H04W 72/0446

(52) U.S. Cl. CPC H04W 76/28; H04W 52/0216; H04W 72/0446

(57) ABSTRACT

A first entity in a communications network that includes a second entity can determine a discontinuous reception (“DRX”) cycle start time based on a number of times a frame number (“FN”) has wrapped around. The first entity can further initiate a DRX cycle at the DRX cycle start time.

### TECHNICAL FIELD

The present disclosure is related to wireless communication systems and more particularly to frame number (“FN”) correction for discontinuous reception (“DRX”).

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

A System Frame Number (“SFN”) can be used to refer to a system frame, which is a timing reference in 5G networks. In some examples, each system frame includes 10 subframes, numbered from 0 to 9. Each subframe can correspond to 1 ms. Thus, one system frame can correspond to 10 ms. In some examples, the SFN can have a value from 0 to 1023 (1024 possible values), corresponding to a total of 10240 ms. A device-to-device frame number (“DFN”) can be used to refer to a device-to-device (“D2D”) frame, which is a timing reference in a sidelink network.

A discontinuous reception (“DRX”) cycle in 5G can refer to a cycle in which a communication device switches between a lower power state (e.g., an idle state) and an active state. In some examples, the communication device saves power in the lower power state by not monitoring a physical downlink control channel, PDCCH, associated with a network node or a physical sidelink control channel, PSCCH, associated with another communication device. To receive messages, the communication device periodically wakes up (e.g., switches to the active state).

### SUMMARY

According to some embodiments, a method of operating a first entity in a communications network that includes a second entity is provided. The method further includes determining a discontinuous reception (“DRX”) cycle start time based on a number of times a frame number (“FN”) has wrapped around. The method further includes initiating a DRX cycle at the DRX cycle start time.

According to other embodiments, a first entity, a network node, a communication device, a computer program, a computer program product, a non-transitory computer-readable medium, a host, or a system is provided to perform the above method.

Certain embodiments may provide one or more of the following technical advantages. In some embodiments, the configured DRX cycle length can be maintained when the frame number (“FN”) wraps around, which can reduce communication delay between two entities when at least one of the entities are operating with a DRX cycle. Reducing the communication delay can improve user experience as well as reduce wasted resources including radio resources, bandwidth, and energy.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a table illustrating an example of a problem with the DRX standard formula;

FIG. 3 is a table illustrating an example of the problem in FIG. 2 being overcome in accordance with some embodiments;

FIG. 4 is a flow chart illustrating examples of operations performed by a first entity in accordance with some embodiments;

FIG. 5 is a block diagram of a communication system in accordance with some embodiments;

FIG. 6 is a block diagram of a user equipment in accordance with some embodiments;

FIG. 7 is a block diagram of a network node in accordance with some embodiments;

FIG. 8 is a block diagram of a host computer communicating with a user equipment in accordance with some embodiments;

FIG. 9 is a block diagram of a virtualization environment in accordance with some embodiments; and

FIG. 10 is a block diagram of a host computer communicating via a base station with a user equipment over a partially wireless connection in accordance with some embodiments.

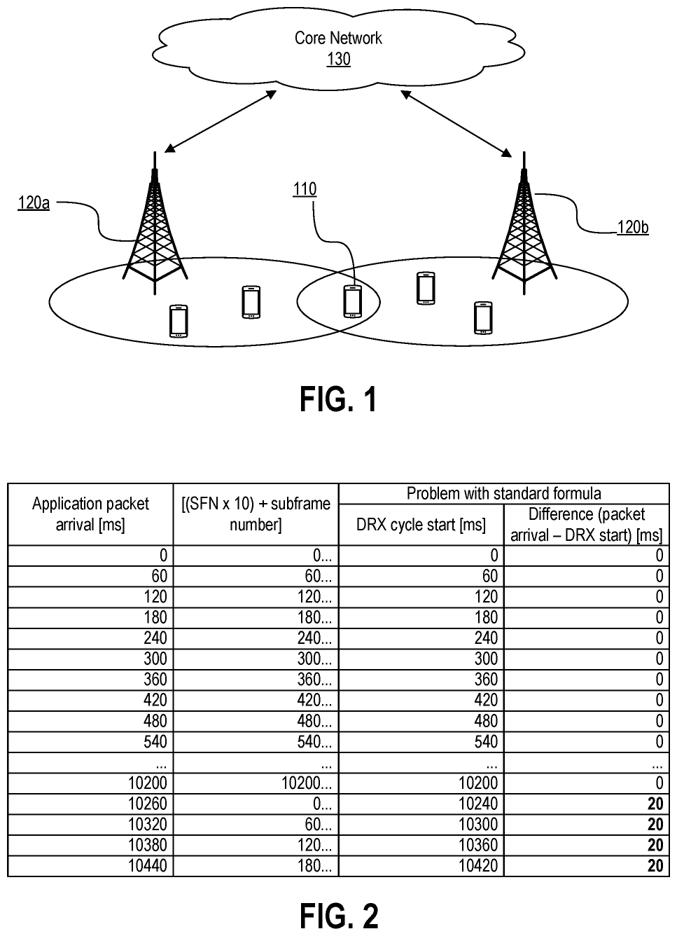

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

A FN (SFN or DFN) can be used in discontinuous reception (“DRX”) functionality to ensure the communication device and the transmitting device (e.g., a network node or another communication device) know when the communication device switches states. In some examples, the DRX cycle start time is the same as the start of the drx-onDurationTimer. The DRX cycle end time is the start of the next DRX cycle, and thus the next time that the drx-onDurationTimer starts. During the “on” portion of the cycle (drx-onDurationTimer running), the UE listens to the PDCCH transmitted by the network. In some aspects, during this “on” portion of the DRX cycle, the network can send a PDCCH to this UE, e.g. for scheduling purposes. Known operations of DRX functionality, in which the UE is able to periodically switch off to save power, and switch on to receive at least a control channel (e.g. PDCCH) are applicable to the present embodiments.

The device and the network each determine independently the DRX cycle start time. However, they should, of course, both use the same rules/formula, so that both determine the exact same DRX cycle start time, for all DRX cycles.

In some examples, for a long DRX cycle, a UE starts its drx-onDurationTimer (e.g., for PDCCH monitoring) based on determining a drx-StartOffset based on

$$[ ( SFN \times 10 ) + subframe number ] modulo ( drx - LongCycle ) = drx - StartOffset .$$

For a short DRX cycle, the UE starts its drx-onDurationTimer (e.g., for PDCCH monitoring) based on determining a drx-StartOffset based on

$$[ ( SFN \times 10 ) + subframe number ] modulo ( drx - ShortCycle ) = ( drx - StartOffset ) modulo ( drx - ShortCycle ) .$$

There currently exist certain challenges. For example, when the DRX service lasts for a period longer than that covered by the total SFN range (e.g., 10240 ms), a difference can form between an application packet arrival and a DRX start. For example, extended reality (“XR”) services can last for a much longer period of time.

FIG. 2 is a table illustrating that the problem can occur when the DRX cycle length is not a factor of 10240 ms. In this example, the DRX cycle value is 60 ms (drx-StartOffset=0) and traffic arrives with a periodicity of 60 ms. It can be observed that when the SFN wraps around (e.g., exceeds its maximum value), the DRX “on Duration” (i.e. drx-onDurationTimer) will start at a different time interval than what it initially did. Specifically, when SFN becomes 0 again, the DRX cycle starts earlier than the configured 60-ms cycle length, namely at moment 10240 ms, which is only 40 ms later than the previous DRX cycle start at 10200 ms. This results in an offset between the application packet arrival to the RAN and the time at which the UE will start monitoring PDCCH. This creates an undesirable added latency that can be added to for every SFN wrap-around.

Certain aspects of the disclosure and their embodiments may provide solutions to these or other challenges. In some embodiments, the DRX cycle start can be determined based on a number of times the SFN has wrapped around. In some examples, determining the DRX cycle start based on the number of times the SFN has wrapped around prevents any offset between the application packet arrival and the DRX cycle start.

Although the following description may generally refer to a discontinuous reception (“DRX”) cycle performed by a communication device communicatively coupled to a network node via a communications network, the embodiments herein may be applicable to other scenarios in which a DRX cycle occurs.

A system frame number (“SFN”) wraparound issue can occur when performing the current operations to determine the start of a drx-onDurationTimer (e.g., [(SFN×10)+subframe number] modulo (drx-LongCycle)=drx-StartOffset). In some examples, the SFN takes values in the range 0 to 1023 and the subframe number can be from 0 to 9, so the term [(SFN×10)+subframe number]ranges from 0 to 10239 and then repeats these values (e.g., every time SFN=0 again). Consequently, if the DRX cycle length is not a factor of 10240 ms, the current operations calculates wrongly the start of the DRX cycle every time the SFN value wraps around. This issue is not specific to extended reality (“XR”) traffic and can occur for any R15/16 DRX cycle length that is not a factor of 10240 ms.

In some embodiments, the operations for determining the start of the drx-onDurationTimer can be modified to [((1024×m+SFN)×10)+subframe number] modulo (drx-LongCycle)=drx-StartOffset, where m=0 when DRX is activated and is incremented every time SFN=0. These modifications do not require an additional configurable parameter to be introduced.

In some embodiments, a communication device and/or a network node can determine a DRX cycle start by determining an amount of time until the DRX cycle starts (drx-StartOffset) based on a number of times that the SFN has wrapped around. In some examples, the drx-StartOffset is adjusted every time there is a SFN wrap-around by adding “(FN_max*m)” where FN_max is a maximum range of the SFN and m is an integer counter that is incremented every time SFN wraps around. In some examples, m may be initialized to zero and incremented in response to the SFN attempting to be incremented to a value that exceeds the FN_max or in response to the SFN returning to a value of zero. Adding “(FN_max*m)” can be enough to prevent mis-alignment.

In additional or alternative embodiments, for a long DRX cycle, the start of the DRX cycle can be determined based on:

$$[ ( FN\_max \times m + SFN ) + subframe number ] modulo ( drx - LongCycle ) = ( drx - StartOffset ) .$$

Similarly, for a short DRX cycle, the start of the DRX cycle can be determined based on:

$$[ ( FN\_max \times m + SFN ) \times 10 + subframe number ] modulo ( dry - ShortCycle ) = ( drx - StrartOffset ) modulo ( drx - ShortCycle ) .$$

In additional or alternative embodiments, m can be maintained using the following operations:

1> Initialize: m=0
1> While DRX is configured and activated:
2> if SFN reaches 0, increment by 1 i.e. m=m+1
1> End while

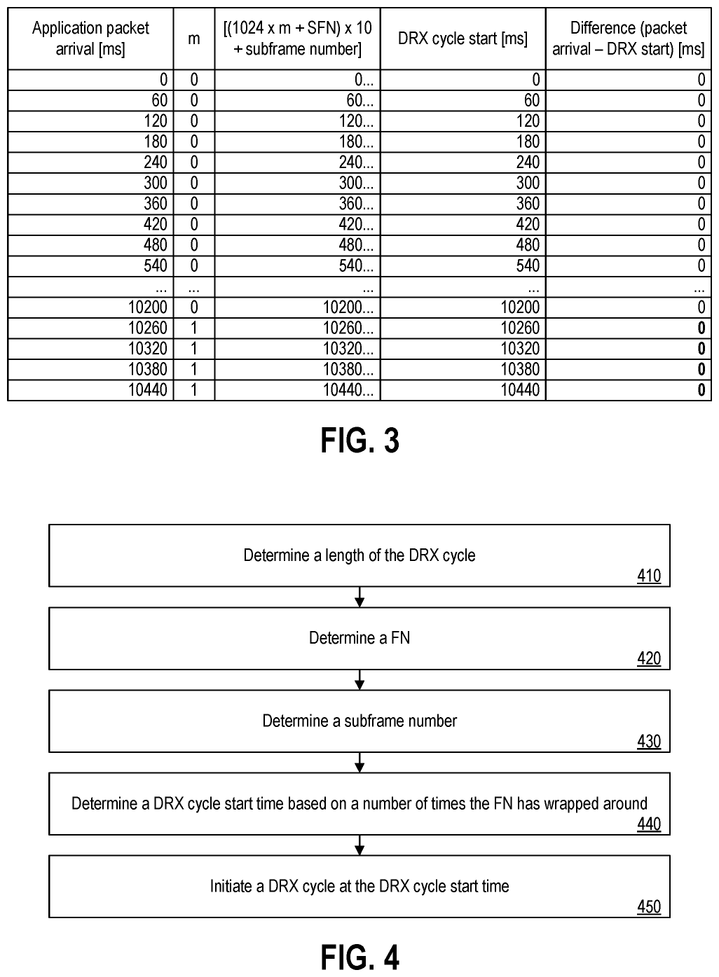

FIG. 3 illustrates an example of how the difference between the packet arrival and DRX start can be eliminated by calculating the DRX cycle start based on the number of times the SFN has wrapped around.

Eliminating the difference between the packet arrival and DRX start can prevent communication delays between an entity operating performing the DRX and another entity. In some examples, preventing the communication delays can improve user experience. In additional or alternative examples, preventing the communication delays and reduce the energy, radio resources, and bandwidth used for communicating (monitoring and/or transmitting) with the other entity.

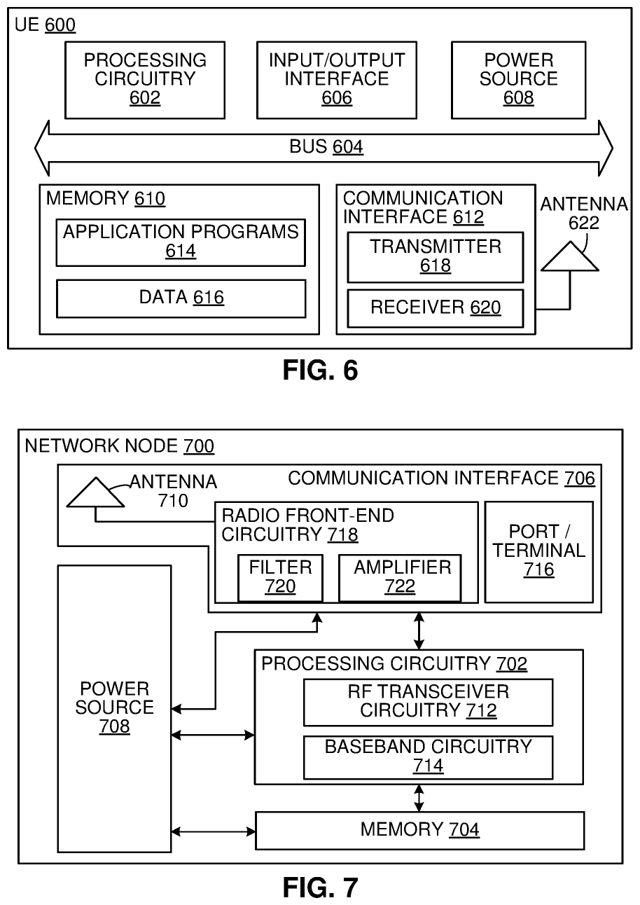

In the description that follows, while the first entity may be any of wireless device 512A-B, wired or wireless devices UE 512C-D, UE 600, Hub 514, network node 510A-B, core network node 508, network node 700, virtualization hardware 904, virtual machines 908A, 908B, network node 1004, or UE 1006, the UE 600 (also referred to herein as communication device 600) shall be used to describe the functionality of the operations of the first entity. Operations of the communication device 600 (implemented using the structure of the block diagram of FIG. 6) will now be discussed with reference to the flow charts of FIG. 4 according to some embodiments of inventive concepts. For example, modules may be stored in memory 610 of FIG. 6, and these modules may provide instructions so that when the instructions of a module are executed by respective communication device processing circuitry 602, processing circuitry 602 performs respective operations of the flow charts.

FIG. 4 illustrates examples of operations performed by a first entity in a communications network that includes a second entity for performing FN correction for DRX.

At block 410, processing circuitry 602 determines a length of the DRX cycle. In some embodiments, determining the length of the DRX cycle includes determining whether the DRX cycle is a long DRX cycle or a short DRX cycle. The length of the DRX cycle can be predetermined or preset.

At block 420, processing circuitry 602 determines a frame number (“FN”). In some examples, the FN is a counter of frames, which are timing references associated with the communications network. In some examples, the FN has a maximum range (“FN_max”) of 1024 (0 to 1023). In some embodiments, the processing circuitry 602 maintains a counter of the number of times that the FN has wrapped around (“m”). In some examples, the number of times that the FN has wrapped around is associated with a number of times that the FN has been incremented beyond the FN_max. When the FN is incremented beyond FN_max (or is attempted to be incremented beyond FN_max) the FN can be set to zero (or reset/returned to zero if it was initialized to zero). In additional or alternative examples, the number of times that the FN has wrapped around is associated with a number of times that the FN has returned to zero. In additional or alternative examples, each frame has a length of 10 ms.

At block 430, processing circuitry 602 determines a subframe number, which is associated with a current subframe of the current frame. In some examples, each frame includes ten subframes (0 to 9). In additional or alternative examples, each subframe has a length of 1 ms.

At block 440, processing circuitry 602 determines a DRX cycle start time based on a number of times the FN has wrapped around. In some embodiments, determining the DRX cycle start time includes determining the DRX cycle start time based on: a maximum range of the FN; the FN; the number of times the FN has wrapped around; the subframe number; and the length of the DRX cycle.

In additional or alternative embodiments, if the DRX cycle is a long DRX cycle, determining the DRX cycle start time includes determining an amount of time until the DRX cycle starts (“drx-StartOffset”) based on:

$$drx - StrartOffset = [ ( FN\_max * m + FN ) * 10 + subframe number ] modulo ( dry - LongCycle )$$

where drx-LongCycle is the length of the DRX cycle.

In additional or alternative embodiments, if the DRX cycle is a short DRX cycle, determining the DRX cycle start time includes determining an amount of time until the DRX cycle starts (“drx-StartOffset”) based on:

$$drx - StrartOffset modulo drx - ShortCycle = [ ( FN\_max * m + FN ) * 10 + subframe number ] modulo ( drx - ShortCycle ) ,$$

where drx-ShortCycle is the length of the DRX cycle.

At block 450, processing circuitry 602 initiates a DRX cycle at the DRX cycle start time. In some embodiments, initiating the DRX cycle includes starting a timer (“drx-onDurationTimer”) associated with a length of the DRX cycle. Thus, in some aspects, the cycle start time is the same as the start of the drx-onDurationTimer, and in some aspects may be used interchangeably.

In additional or alternative embodiments, the first entity is a communication device and the second entity is a network node. The FN can be a SFN. In some examples, initiating the DRX cycle includes monitoring a physical downlink control channel (“PDCCH”) for transmissions from the network node, e.g. for the “on” portion of the DRX cycle. In additional or alternative examples, the transmissions from the network node are multicast broadcast services (“MBS”) broadcast transmissions or MBS multicast transmissions.

In additional or alternative embodiments, the first entity is a first communication device and the second entity is a second communication device. The FN can be a device-to-device FN (“DFN”). In some examples, the communications network is a sidelink communications network. In additional or alternative examples, the DRX cycle is a sidelink DRX cycle. In additional or alternative examples, initiating the sidelink DRX cycle includes monitoring a physical sidelink control channel (“PSCCH”) for transmissions from the second communication device. In additional or alternative examples, initiating the sidelink DRX cycle includes transmitting a signal to the second communication device via the PSCCH.

In additional or alternative embodiments, determining the start of the DRX cycle includes determining an amount of time until a sidelink DRX cycle start (e.g., sl-drx-Start Offset) based on:

$$sl - drx - StartOffset = [ ( FN\_max * m + DFN ) * 10 + subframe number ] modulo ( sl - drx - Cycle ) ,$$

where sl-drx-Cycle is a length of the sidelink DRX cycle.

Although FIG. 4 is described in regards to a communication device, the operations can be performed by any suitable entity such as a network node (e.g., network node 700). In some embodiments, the first entity is a network node and the second entity is a communication device. The FN can be a SFN. In some examples, initiating the DRX cycle includes transmitting signal to the communication device via a PDCCH. In additional or alternative examples, transmitting the signal includes transmitting a MBS broadcast signal or a MBS multicast signal.

Various operations illustrated in FIG. 4 may be optional in respect to some embodiments. For example, in regards to Embodiment 1 (below), blocks 410, 420, and 430 are optional.

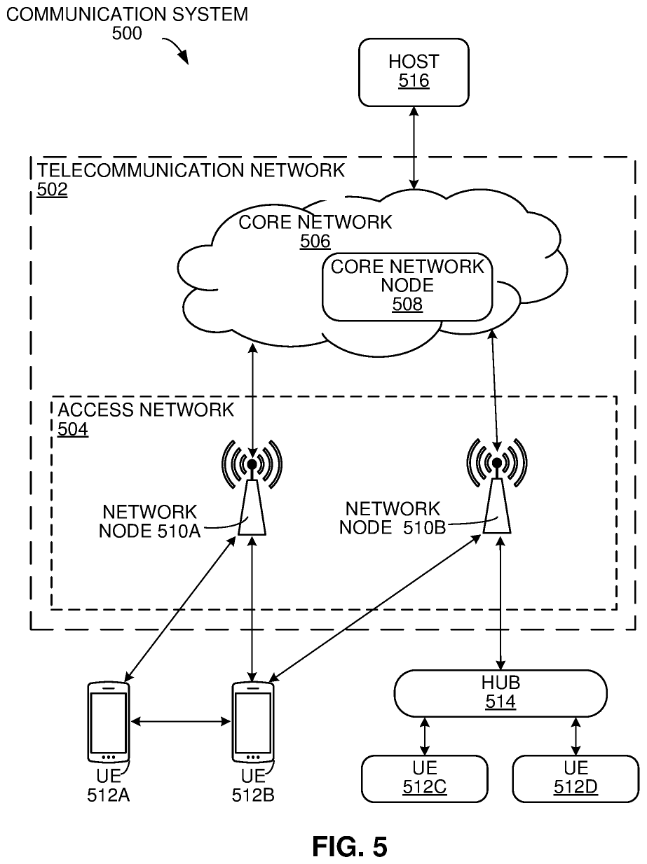

FIG. 5 shows an example of a communication system 500 in accordance with some embodiments.

In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. Moreover, as will be appreciated by those of skill in the art, the network nodes 510 are not necessarily limited to an implementation in which a radio portion and a baseband portion are supplied and integrated by a single vendor. Thus, it will be understood that the network nodes 510 may include disaggregated implementations or portions thereof. For example, in some embodiments, the telecommunication network 502 includes one or more Open-RAN (ORAN) network nodes. An ORAN network node is a node in the telecommunication network 502 that supports an ORAN specification (e.g., a specification published by the O-RAN Alliance, or any similar organization) and may operate alone or together with other nodes to implement one or more functionalities of any node in the telecommunication network 502, including one or more network nodes 510 and/or core network nodes 508.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 510 facilitate direct or indirect connection of user equipment (UE), such as by connecting wireless devices 512a, 512b, 512c, and 512d (one or more of which may be generally referred to as UEs 512) to the core network 506 over one or more wireless connections. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

FIG. 6 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 7 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, 0-DU, 0-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

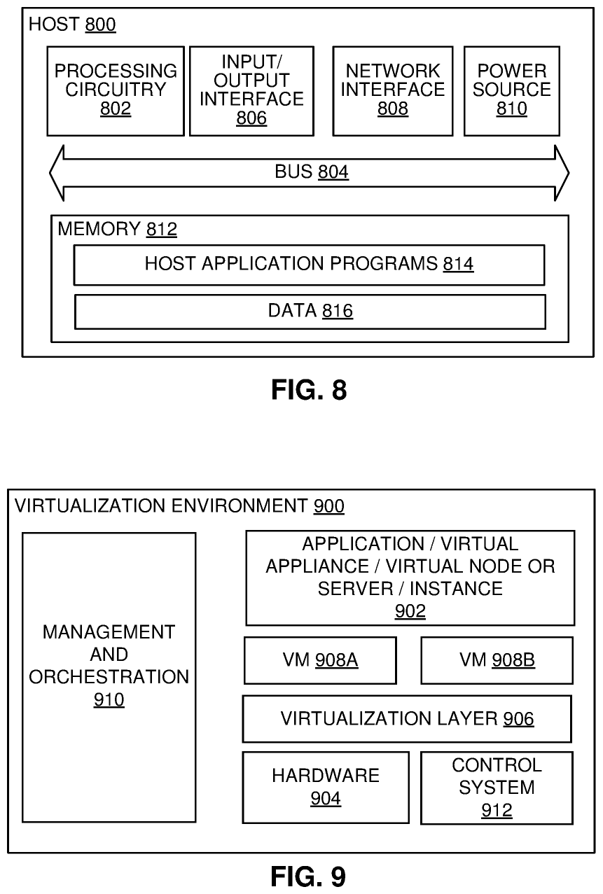

FIG. 8 is a block diagram of a host 800, which may be an embodiment of the host 516 of FIG. 5, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 900 includes components defined by the O-RAN Alliance, such as an O-Cloud environment orchestrated by a Service Management and Orchestration Framework via an O-2 interface.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

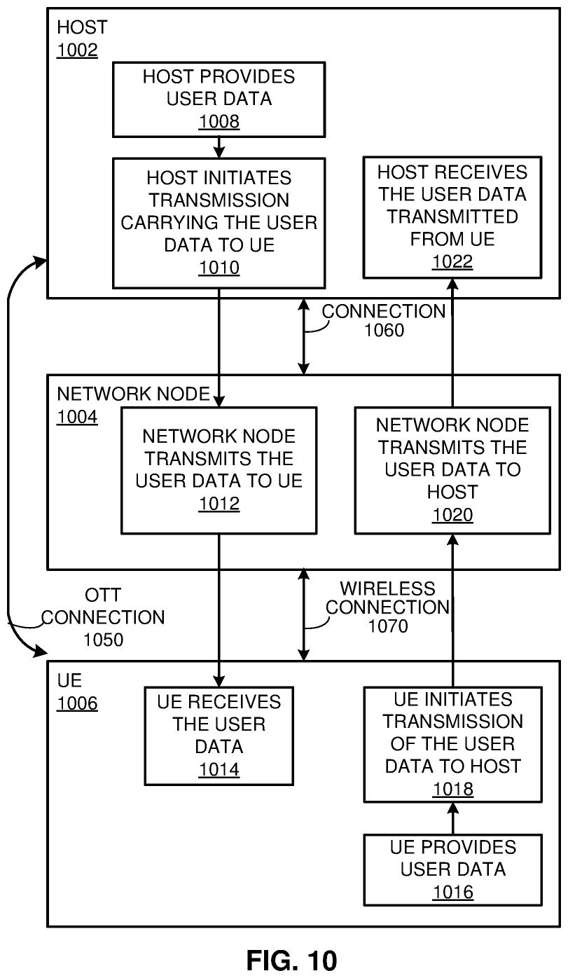

FIG. 10 shows a communication diagram of a host 1002 communicating via a network node 1004 with a UE 1006 over a partially wireless connection in accordance with some embodiments. Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may maintain the configured DRX cycle length when the FN wraps around, which can reduce communication delay between two entities when at least one of the entities are operating with a DRX cycle. Reducing the communication delay can improve user experience as well as reduce wasted resources including radio resources, bandwidth, and energy.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a first entity in a communications network that includes a second entity, the method comprising:
determining a discontinuous reception, DRX, cycle start time based on a number of times a frame number, FN, has wrapped around; and
initiating a DRX cycle at the DRX cycle start time.

2. The method of claim 1, wherein FN is a counter of frames, which are timing references associated with the communications network, the FN having a maximum range, FN_max.

3. The method of claim 2, wherein the number of times the FN has wrapped around is associated with a number of times the FN has been incremented beyond the FN_max.

4. The method of claim 1, wherein the number of times that the FN has wrapped around is associated with a number of times that the FN has returned to zero.

5. The method of claim 1, further comprising:
determining a length of the DRX cycle;
determining the FN associated with a current frame; and
determining a subframe number associated with a current subframe of the current frame,
wherein determining the DRX cycle start time comprises determining the DRX cycle start time based on:
a maximum range of the FN, FN_max;
the FN;
the number of times the FN has wrapped around, m;
the subframe number; and
the length of the DRX cycle.

6. The method of claim 5, wherein determining the length of the DRX cycle comprises determining the DRX cycle is a long DRX cycle,
wherein determining the DRX cycle start time comprises determining an amount of time until the DRX cycle starts, drx-StartOffset, based on:
$$drx - StartOffset = [ ( FN\_max * m + FN ) * 10 + subframe number ] modulo ( drx - LongCycle ) ,$$
where drx-LongCycle is the length of the DRX cycle.

7. The method of claim 5, wherein determining the length of the DRX cycle comprises determining the DRX cycle is a short DRX cycle,
wherein determining the DRX cycle start time comprises determining an amount of time until the DRX cycle starts, drx-StartOffset, based on:
$$drx - StartOffset modulo drx - ShortCycle = [ ( FN\_max * m + FN ) * 10 + subframe number ] modulo ( drx - ShortCycle ) ,$$
where drx-ShortCycle is the length of the DRX cycle.

8. The method of claim 5, wherein the FN_max is 1024,
wherein each frame is associated with a FN between 0 and 1023,
wherein each frame comprises ten subframes, and
wherein each subframe of the ten subframes is associated with a subframe number between 0 and 9.

9. The method of claim 8, wherein each frame has a length of 10 ms, and
wherein each subframe has a length of 1 ms.

10. The method of claim 1, wherein initiating the DRX cycle comprises starting a timer, drx-onDurationTimer, associated with a length of the DRX cycle.

11. The method of claim 1, wherein the first entity is a communication device and the second entity is a network node, and
wherein the FN is a system FN, SFN.

12. The method of claim 11, wherein initiating the DRX cycle comprises monitoring a physical downlink control channel, PDCCH, for transmissions from the network node.

13. The method of claim 12, wherein the transmissions from the network node are at least one of:
multicast broadcast services, MBS, broadcast transmissions; and
MBS multicast transmissions.

14. The method of claim 1, wherein the first entity is a first communication device and the second entity is a second communication device,
wherein the communications network is a sidelink communications network, and
wherein the FN is a device-to-device FN, DFN.

15. The method of claim 14, wherein the DRX cycle is a sidelink DRX cycle, and
wherein initiating the sidelink DRX cycle comprises at least one of:
monitoring a physical sidelink control channel, PSCCH, for transmissions from the second communication device; and
transmitting a signal to the second communication device via the PSCCH.

16. The method of claim 1, wherein the first entity is a network node and the second entity is a communication device, and
wherein the FN is a system FN, SFN.

17. The method of claim 16, wherein initiating the DRX cycle comprises transmitting a signal to the communication device via a physical downlink control channel, PDCCH.

18. The method of claim 17, wherein transmitting the signal comprises transmitting at least one of:
a multicast broadcast services, MBS, broadcast signal; and
a MBS multicast signal.

19. A first entity operating in a communications network, the first entity comprising:
processing circuitry; and
memory coupled to the processing circuitry and having instructions stored therein that are executable by the processing circuitry to cause the first entity to perform operations comprising any of the operations of claim 1.

20-22. (canceled)
